(19) United States
(12) Patent Application Publication
(10) Pub. No.: US 2026/0313462 A1
(43) Pub. Date: Oct. 8, 2026

(54) UPLINK BIT RATE ASSISTANCE INFORMATION

(71) Applicant: Apple Inc., Cupertino, CA (US)

(72) Inventors: Ping-Heng KUO, London (GB); Alexander SIROTKIN, Hod Hasharon (IL); Fangli XU, Beijing (CN); Haijing HU, Los Gatos, CA (US); Naveen Kumar R. PALLE VENKATA, San Diego, CA (US); Peng CHENG, Beijing (CN); Ralf ROSSBACH, Munich (DE); Yuqin CHEN, Beijing (CN); Zhibin WU, Los Altos, CA (US)

(21) Appl. No.: 19/482,537

(22) PCT Filed: Nov. 4, 2024
(86) PCT No.: PCT/CN2024/130444

§ 371 Date: Nov. 7, 2025

(51) Int. Cl. H04W 28/12; H04W 28/02; H04W 80/02

(52) U.S. Cl. CPC H04W 28/12; H04W 28/0268; H04W 80/02

(57) ABSTRACT

In accordance with aspects of the present disclosure, a user equipment (UE) may be configured to provide uplink bit rate assistance information to an access node. The uplink bit rate assistance information can include, e. g., a minimum uplink bit rate, a target uplink bit rate, a difference between the minimum and target uplink bit rates, and/or a list of supported uplink bit rates for a particular data transport entity, which can include a quality of service (QOS) flow, a data radio bearer (DRB), or a logical channel (LCH). The UE can provide the uplink bit rate assistance information to the access node via a UE assistance information (UAI) message or a recommended bit rate query message. The access node can use the uplink bit rate assistance information provided by the UE to configure a suitable uplink bit rate for the associated logical data transport entity.

### TECHNICAL FIELD

The present disclosure generally relates to signaling uplink bit rate assistance information for a data transport entity.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

One aspect of the present disclosure relates to a method including: generating a message that includes uplink bit rate assistance information for a data transport entity; and transmitting the message to an access node.

Another aspect of the present disclosure relates to a method including: receiving, from a user equipment (UE), a message including uplink bit rate assistance information for a data transport entity.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates an example recommended bit rate medium access control (MAC) control element (CE), according to some implementations.

FIG. 3 illustrates an example recommended bit rate table, according to some implementations.

FIGS. 4 and 5 illustrate example process flows, according to some implementations.

FIG. 6 illustrates an example bit rate recommendation query message, according to some implementations.

FIGS. 7 and 8 illustrate flowcharts of example methods, according to some implementations.

FIG. 9 illustrates an example user equipment (UE), according to some implementations.

FIG. 10 illustrates an example access node, according to some implementations.

### DETAILED DESCRIPTION

In some wireless systems, if a base station (referred to hereinafter as a gNB) detects a condition relating to a network status (e.g. congestion) while communicating with a user equipment (UE), the gNB may instruct the UE to use a different bit rate. The gNB may indicate the new bit rate (also referred to as a data rate, a coding rate, or a codec rate) using a recommended bit rate medium access control (MAC) control element (CE) that includes a logical channel identifier (LCID), a transmission direction (uplink or downlink), a bit rate, and a bit rate multiplier. The recommended bit rate MAC-CE sets the effective bit rate for all traffic flows or quality of service (QOS) flows (also referred to as logical data transport entities) associated with the specified LCID, which makes it suitable for voice communications. For some extended reality (XR) or augmented reality (AR) applications, however, it may be desirable to have different bit rates for different traffic flows (e.g., audio, video, spatial data), as some traffic flows may have different bit rate constraints.

In accordance with aspects of the present disclosure, a UE may be configured to provide uplink bit rate assistance information to a gNB. The uplink bit rate assistance information can include, e.g., a minimum uplink bit rate, a target uplink bit rate, a difference between the minimum and target uplink bit rates, and/or a list of supported uplink bit rates for a particular data transport entity, which can be a QoS flow, data radio bearer (DRB), or logical channel (LCH). The UE can provide the uplink bit rate assistance information to the gNB via a UE assistance information (UAI) message or a recommended bit rate query message. The gNB can use the uplink bit rate assistance information provided by the UE to configure a suitable uplink bit rate for the associated logical data transport entities (e.g., QoS flows, DRBs, or LCHs). In some implementations, the UE and/or the gNB can use configurable bit rate multipliers or tables to indicate a minimum, target, or supported uplink bit rate for a particular data transport entity.

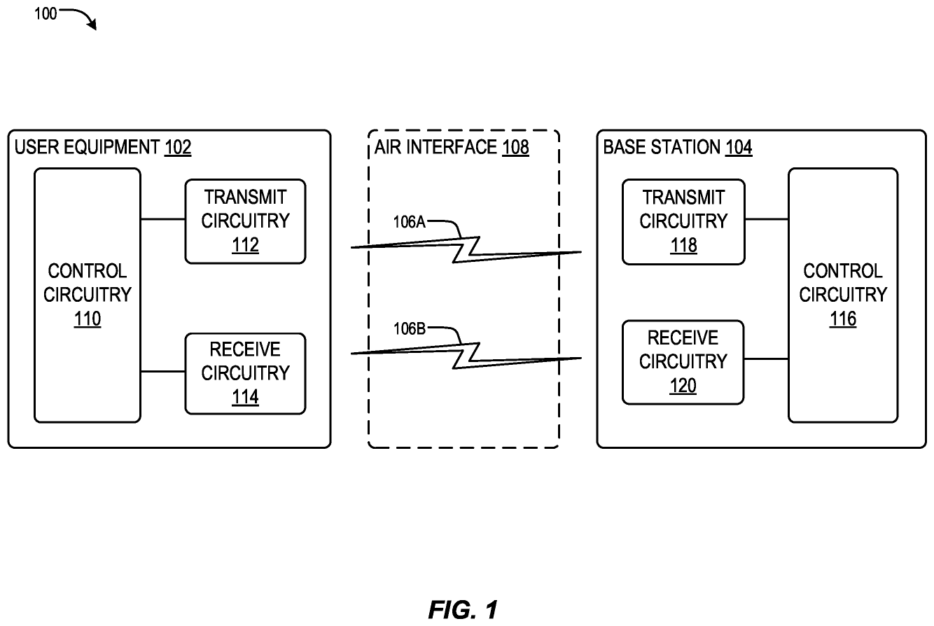

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For example, the control circuitry 110 can determine a minimum, target, or supported uplink coding bit rate for a data transport entity (e.g., QoS flow, DRB, or LCH) based on information provided by higher layers.

The transmit circuitry 112 can perform various operations described herein. For example, the transmit circuitry 112 can transmit UAI or a query message indicating the minimum, target, or supported uplink coding bit rate for the data transport entity. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 can perform various operations described herein. For example, the receive circuitry 114 can receive control signaling that configures a suitable uplink coding bit rate for the data transport entity based on the UAI or query message. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

Some aspects of the present disclosure involve signaling bit rates for specific QoS flows to ensure good XR performance/quality. Existing flow bit rate parameters like guaranteed flow bit rate (GFBR) and maximum flow bit rate (MFBR) indicate which bit rate is needed for a QoS flow. GFBR and MFBR are the absolute bounds the network has to support for a QoS flow. GFBR is only applicable to guaranteed bit rate (GBR) traffic flows. By contrast, the recommended bit rate query message described herein indicates the desired or target bit rate of the UE 102. This desired bit rate should be within the range defined by MFBR and GFBR. However, there is no restriction on how the UE 102 derives this desired rate. Eventually, the base station 104 will select or recommend a suitable bit rate that is within this range. In accordance with aspects of the present disclosure, the UE can indicate a desired range of bit rates in the query message, which may not be related to MFBR and GFBR. This allows the base station 104 to determine the bit rate recommendation by considering the desired bit rate of the UE 102.

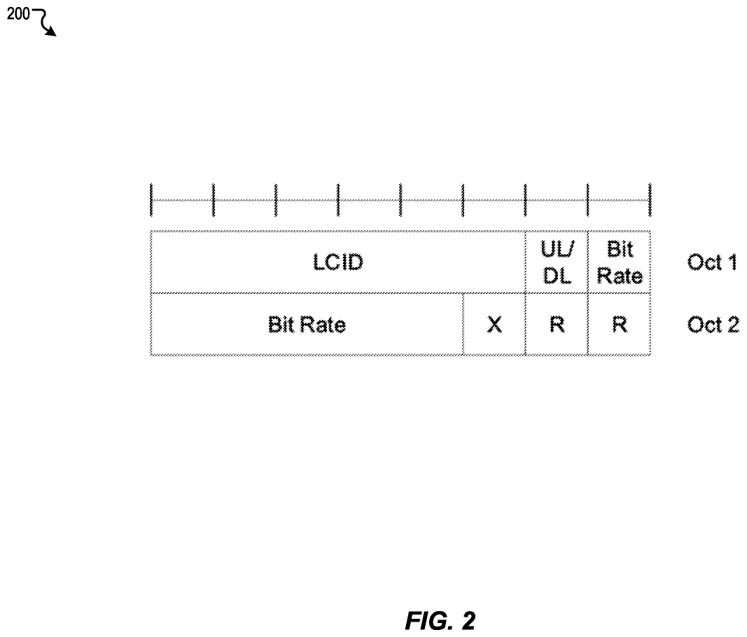

FIG. 2 illustrates an example recommended bit rate MAC-CE 200, according to some implementations. The recommended bit rate MAC-CE 200 of FIG. 2 includes an LCID field, a UL/DL field, a bit rate field, a bit rate multiplier field (denoted as X), and one or more reserved bits (denoted as R). The recommended bit rate MAC-CE 200 is identified by a MAC subheader with an LCID for bit rate recommendation from the gNB to the UE and bit rate recommendation query message from the UE to the gNB, respectively. The recommended bit rate MAC-CE 200 has a fixed size and includes two octets. The first octet includes the LCID field, the UL/DL field, and part of the bit rate field. The second octet includes part of the bit rate field, the bit rate multiplier field, and the reserved bits.

The LCID field indicates the identity of the LCH for which the recommended bit rate or the recommended bit rate query is applicable. The length of the LCID field is 6 bits. The UL/DL field indicates whether the recommended bit rate or the recommended bit rate query applies to uplink or downlink. The length of the UL/DL field is 1 bit. The UL/DL field is set to 0 to indicate downlink. A value of 1 indicates uplink.

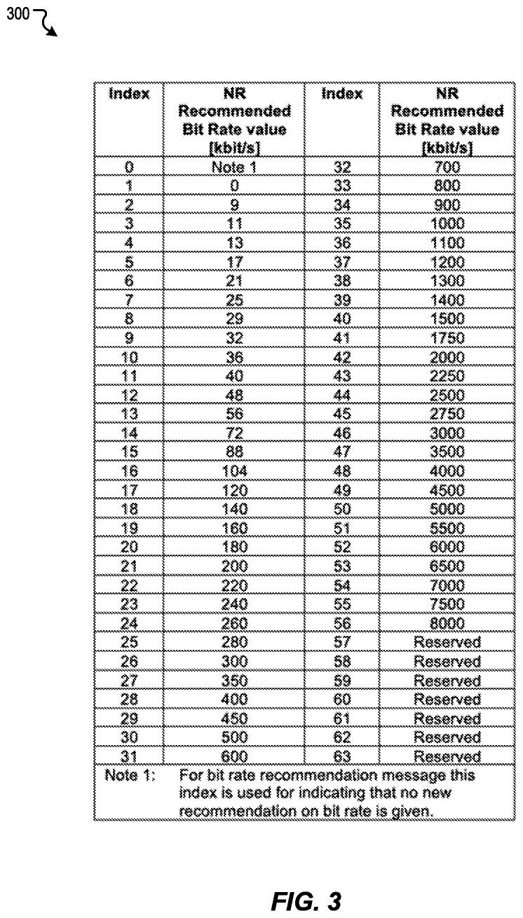

The bit rate field indicates an index of a bit rate table (as shown and described with reference to FIG. 3). The length of the bit rate field is 6 bits. For bit rate recommendations, the value indicates the recommended bit rate. For bit rate recommendation queries, the value indicates the desired bit rate.

For UEs that support recommended bit rate multipliers, when bitRateMultiplier (3GPP TS 38.331) is configured for the LCH indicated by the LCID field and the bit rate multiplier field is set to 1, the actual value of the bit rate is the value corresponding to the index indicated by the bit rate field multiplied by the value of bitRateMultiplier. Additional details about the recommended bit rate MAC-CE 200 can be found in 3GPP TS 38.321.

The recommended bit rate MAC-CE 200 can be used to support voice communications. However, for XR applications that are supported by multiple traffic flows with potentially different QoS flow requirements, finer granularity for recommended bit rate indications may be desirable (e.g., per QoS flow instead of per DRB), as the data rate for XR applications is typically higher than voice communications. Consequently, it may be desirable to specify (in the MAC layer) XR rate control signaling (e.g., uplink congestion signaling) over downlink to enable faster bit rate adaption to uplink congestion. This indication can be per DRB or per QoS flow. To provide recommended bit rate values that are better suited for XR applications, the bit rate field of the recommended bit rate MAC-CE 200 can be extended, a new bit rate table can be defined to provide sufficient granularity for XR traffic flows, and new values can be introduced for bitRateMultiplier.

For XR applications, user experience is crucial. An XR traffic flow (e.g., QoS flow, DRB, or LCH) may be associated with a range of bit rates where the application can be adapted. Each XR traffic flow may have a target (e.g., optimal) bit rate and a minimum (e.g., acceptable) bit rate in accordance with the instantaneous operation of the application. To ensure a sustainable quality of experience for an XR application, the bit rate should be maintained within a range between the target and minimum values associated with the corresponding XR traffic flow. With the current framework, however, the network may not know the minimum bit rate for a particular traffic flow at a specific time. Accordingly, the network may recommend an inappropriate bit rate for the XR application (e.g., a bit rate that is lower than the minimum bit rate that can support an acceptable user experience of the XR application).

In accordance with aspects of the present disclosure, a UE can inform the network of the minimum, target, or supported bit rate(s) for an XR application traffic flow via UAI or a recommended bit rate query message. Accordingly, the network can recommend more suitable uplink bit rates for the associated traffic flows. The techniques described herein also provide greater flexibility in signaling bit rates, which can be useful when the UE has multiple concurrent XR traffic flows with different constraints.

FIG. 3 illustrates an example recommended bit rate table 300, according to some implementations. Each row of the recommended bit rate table 300 includes an index and a corresponding NR recommended bit value (in kbit/s). As described with reference to FIG. 2, the bit rate field of the recommended bit rate MAC-CE 200 may indicate a particular index of the recommended bit rate table 300. For bit rate recommendation messages, an index of 0 indicates that no new recommendation on bit rate is provided.

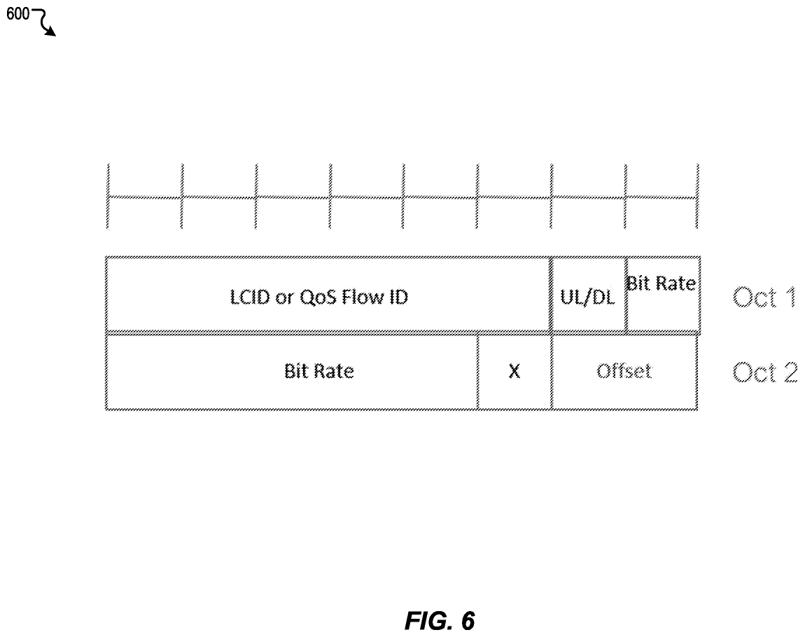

In accordance with aspects of the present disclosure, two or more bit rate tables (including the recommended bit rate table 300 and a new table for XR) may be introduced. A bit rate recommendation query message (provided by the UE) or a bit rate recommendation message (sent from the network) can be modified to indicate which bit rate table is applicable. Different bit rate tables can be used for different QoS flows, LCHs, or DRBs. To support dynamic bit rate table selection, one or more new fields can be added to the MAC-CE format of the bit rate recommendation query message and/or the bit rate recommendation message (e.g., the MAC-CE format shown in FIG. 2 or the MAC-CE format shown in FIG. 6). These fields can be signaled per QoS flow, per LCH, or per DRB. In some implementations, the same bit rate table is used for all QoS flows, LCHs, or DRBs indicated by the same MAC CE.

In some implementations, instead of using a fixed bit rate table (such as the recommended bit rate table 300), the UE and/or the network may dynamically (or semi-statically) generate one or more bit rate tables based on semi-static signaling (e.g., a semi-static configuration). The network may configure parameters for the UE to generate bit rate tables for each QoS flow, DRB, or LCH. For example, the network may configure parameters such as the maximum bit rate value in a table, the minimum bit rate value in the table, and a step size for the table. Accordingly, the UE can semi-statically generate the table using the parameters configured by the network.

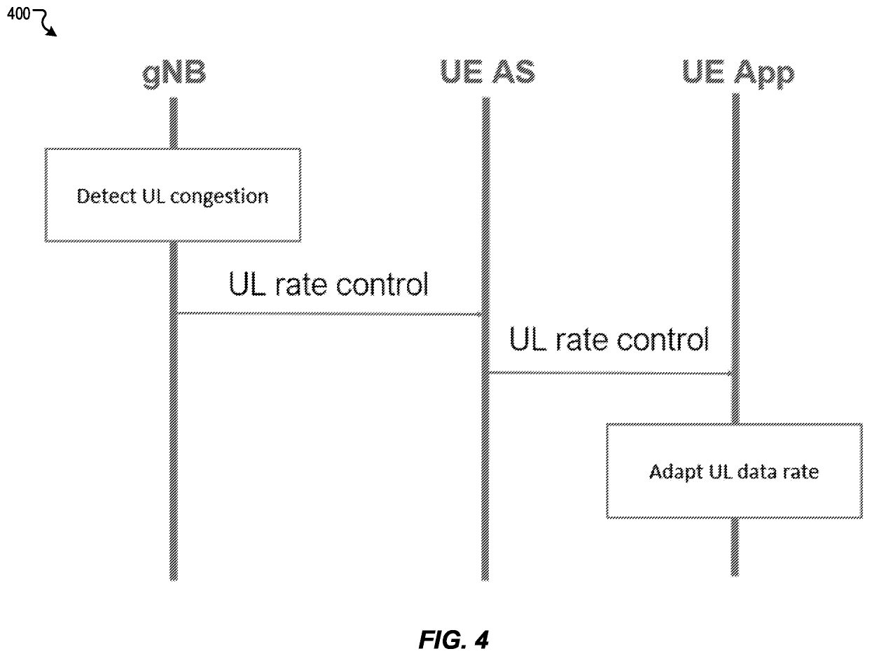

FIG. 4 illustrates an example process flow 400, according to some implementations. The process flow 400 of FIG. 4 illustrates communications between a gNB, an access stratum (AS) layer of a UE, and an application layer of the UE. The process flow 400 of FIG. 4 shows a mechanism by which the gNB (e.g., the network) can send downlink signaling to enable the application layer of the UE to adapt a bit rate accordingly.

In the process flow 400, the gNB detects uplink congestion and transmits uplink rate control signaling to the AS layer of the UE. The uplink rate control signaling may configure the UE to use a different bit rate until network conditions improve. The AS layer of the UE may provide this information to the application layer of the UE, which can adapt the uplink data rate accordingly. In some cases, however, the network may not know the minimum bit rate for a particular data transport entity. Consequently, the network may recommend an inappropriate bit rate for the data transport entity (e.g., a bit rate that is lower than the minimum bit rate for the data transport entity that can be tolerated by the application layer), which can result in poor user experience such as frozen or low-resolution video frames, etc.

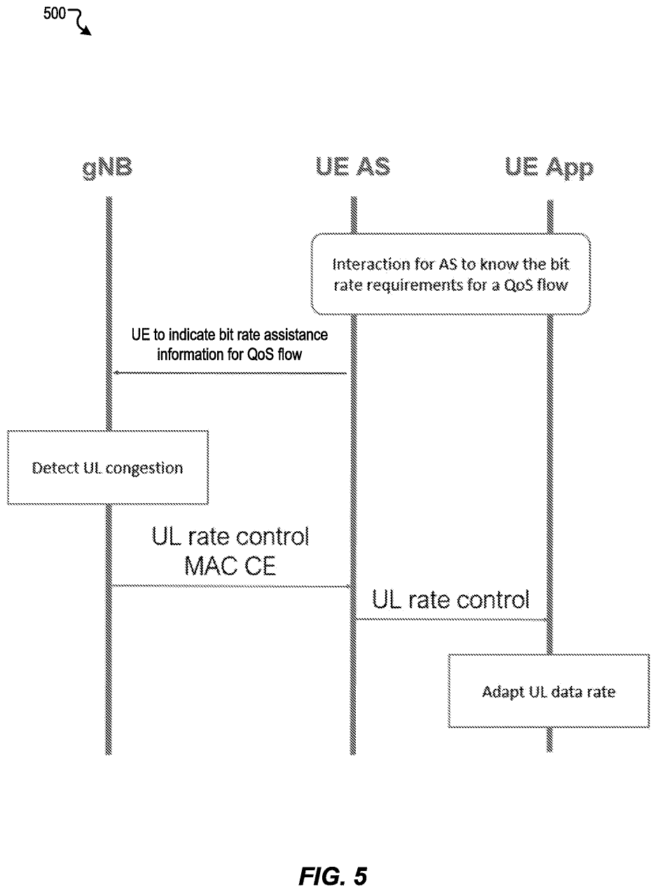

FIG. 5 illustrates an example process flow 500, according to some implementations. The process flow 500 of FIG. 5 illustrates communications between a gNB, an AS layer of a UE, and an application layer of the UE. The process flow 500 of FIG. 5 shows a mechanism by which the gNB (e.g., the network) can send downlink signaling to enable the application layer of the UE to adapt an uplink bit rate accordingly.

In the process flow 500, the gNB detects uplink congestion and transmits uplink rate control signaling to the AS layer of the UE. The uplink rate control signaling may configure the UE to use a different uplink bit rate. The AS layer of the UE may provide this information to the application layer of the UE, which can adapt the uplink bit rate accordingly. Unlike the process flow 400, however, the UE can inform the network of the minimum, target, or supported bit rate(s) for a data transport entity beforehand, such that the network can recommend more suitable uplink bit rates for the data transport entity.

In some implementations, the UE can provide this bit rate assistance information to the network by means of a UAI message. For example, the UE may be configured to transmit a UAI message indicating at least one of the following: the ideal (target) bit rate for a QoS flow, the minimum bit rate for a QoS flow, a list of supported bit rates for a QoS flow, the ideal (target) bit rate for an LCH or DRB, the minimum bit rate for a logical channel or DRB, or a list of supported bit rates for an LCH or DRB. In some implementations, the ideal (target) bit rate can be omitted, as the network can derive this information from the associated QoS profile. In some implementations, the techniques described herein can be extended to other QoS parameters, such as latency budget.

The bit rate assistance information can be provided via the UAI framework. In particular, if information per QoS flow is provided, the ul-TrafficInfo IE in an UAI message (specified in 3GPP TS 38.331) can be extended. Currently, the ul-TrafficInfo IE is used to provide information for an uplink QoS flow, such as jitter range, burst arrival time, PDU set identification, etc. In accordance with aspects of the present disclosure, the ul-TrafficInfo IE can be extended to include at least one of the following: the ideal (target) bit rate for the associated QOS flow; the minimum bit rate for the associated QoS flow; the difference or offset between the ideal (target) bit rate and the minimum bit rate for the associated QoS flow, a list of supported bit rates for the associated QoS flow; or the bit rate adaptability for the associated QoS flow (e.g., whether the bit rate for the corresponding application can be adapted. If the bit rate for the associated QoS flow cannot be adapted, the network may refrain from instructing/recommending bit rate adaptation for this QoS flow).

FIG. 6 illustrates an example bit rate recommendation query message 600, according to some implementations. The bit rate recommendation query message 600 of FIG. 6 includes an LCID or QoS Flow ID field, a UL/DL field, a bit rate field, a bit rate multiplier field (denoted as X), and an offset field.

As described with reference to FIG. 2, the UL/DL field of the bit rate recommendation query message 600 indicates whether the recommended bit rate query applies to uplink or downlink. The length of the UL/DL field is 1 bit. A value of 0 indicates downlink, and a value of 1 indicates uplink. The bit rate field indicates an index of a bit rate table (such as the recommended bit rate table 300, a new recommended bit table for XR, or a semi-statically generated bit rate table). The length of the bit rate field is 6 bits. The value of the bit rate field may indicate the desired bit rate.

For UEs that support recommended bit rate multipliers, when bitRateMultiplier is configured for the LCH, DRB, or QoS flow indicated by the LCID or QoS Flow ID field and the bit rate multiplier field is set to 1, the actual value of the bit rate may be the value corresponding to the index indicated by the bit rate field multiplied by the value of bitRateMultiplier.

As described herein, a UE may be configured to provide uplink bit rate assistance information to a gNB. The uplink bit rate assistance information can include, e.g., a minimum uplink bit rate, a target uplink bit rate, and/or a list of supported uplink bit rates for a particular QoS flow, DRB, or LCH. The gNB can use the uplink bit rate assistance information provided by the UE to configure a suitable uplink bit rate for the associated logical data transport entities (e.g., QoS flows, DRBs, or LCHs).

In some implementations, the uplink bit rate assistance information can be signaled via a UAI message (as described with reference to FIG. 5). In other implementations, the UE can dynamically send a recommended bit rate query message (e.g., based on MAC CE) with the following uplink bit rate assistance information: an indication of the LCH(s) or DRB(s) to which the query message pertains (this could be an explicit ID or a bitmap); an indication of the QoS flow(s) to which the query message pertains (this could also be an explicit ID or a bitmap); the desired bit rate(s) for the applicable LCH(s), DRB(s), or QoS flow(s); the minimum acceptable bit rate(s) for the applicable LCH(s), DRB(s), or QoS flow(s); or the difference or offset between the desired bit rate and the minimum acceptable bit rate of the applicable LCH(s), DRB(s), or QOS flow(s).

The MAC CE structure shown in FIG. 6 allows the UE to indicate the minimum acceptable bit rate for an LCH, DRB, or QoS flow using an offset field, where the minimum acceptable bit rate is equal to the difference between the bit rate (indicated by the bit rate field) and the offset.

Currently, the bit rate multiplier field of the recommended bit rate MAC-CE is configured per LCH, and a fixed value is used in all cases. To provide greater flexibility, the bit rate multiplier value can be dynamically indicated using the MAC CE format depicted in FIG. 6. A UE can indicate a bit rate multiplier value in the bit rate recommendation query message 600. The network can indicate a bit rate multiplier value in a corresponding bit rate recommendation message.

In some embodiments, the network can pre-configure a set or a subset of applicable bit rate multiplier values for at least one LCH, DRB, or QoS flow. In turn, the UE or the network can choose a bit rate multiplier value from the configured set or subset when constructing the MAC CE. For example, if the configured subset includes 4 different bit rate multiplier values, a 2-bit field in the MAC CE can indicate which bit rate multiplier value is used.

Different multiplier values can be indicated for different QoS flows, LCHs, or DRBs, e.g., different values can be used for GBR and non-GBR flows. In some embodiments, different sets or subsets of applicable multiplier values can be configured for different QoS flows, LCHs, or DRBs (e.g., different for GBR and non-GBR flows). In some embodiments, the same multiplier value can be used for all QoS flows, LCHs, or DRBs indicated by the same MAC CE.

In some implementations, rather than using fixed bit rate multiplier values and bit rate tables, a UE can semi-statically generate one or more bit rate multiplier values and/or bit rate tables (as described with reference to FIG. 3). For each QoS flow or LCH/DRB, the network may configure some parameters for the UE to (i) generate a set of bit rate multiplier values or (ii) generate one or more bit rate tables. The generated bit rate multiplier value sets and/or bit rate tables may be applicable to bit rate recommendation (and query) messages pertaining to the corresponding QoS flow(s) or LCH(s).

To semi-statically generate a bit rate multiplier value set, the network may configure parameters such as the maximum bit rate multiplier, the minimum bit rate multiplier, and the step size. Accordingly, the UE can dynamically generate a set of possible bit rate multiplier values using the parameters provided by the network. The values of these parameters may be configured differently for GBR and non-GBR flows.

A new prohibit timer can be configured for the bit rate recommendation query message 600. When a bit rate recommendation query message 600 for a specific QoS flow or LCH is transmitted, the UE can start the prohibit timer. Different prohibit timer values can be configured for different QoS flows and LCHs, such that query messages for some QoS flows or LCHs can be transmitted more frequently than others. In some embodiments, a common prohibit timer value can be used for all QoS flows and LCHs. Different prohibit timers can be used for GBR and non-GBR traffic flows.

In some implementations, the UE may be unable to transmit another query message for the same QoS flow or LCH until the prohibit timer expires. In other implementations, the UE may conditionally transmit a query message for a QoS flow or an LCH, even if the prohibit timer is running (e.g., by stopping the prohibit timer). For example, if the query message (e.g., MAC CE) can convey the desired bit rates for multiple QoS flows or LCHs concurrently, the UE can still transmit a query message for some QoS flows or LCHs, even if their prohibit timer is running (e.g., not yet expired). The UE can restart the prohibit timer when the query message is transmitted. In another example, the UE can stop the prohibit timer before it expires to transmit the query message sooner (e.g., if specific types of packets are identified in the QoS flow or the LCH). The UE can do this if, for example, an important packet arrives in the buffer, and the packet is desired to be transmitted with a particular data rate.

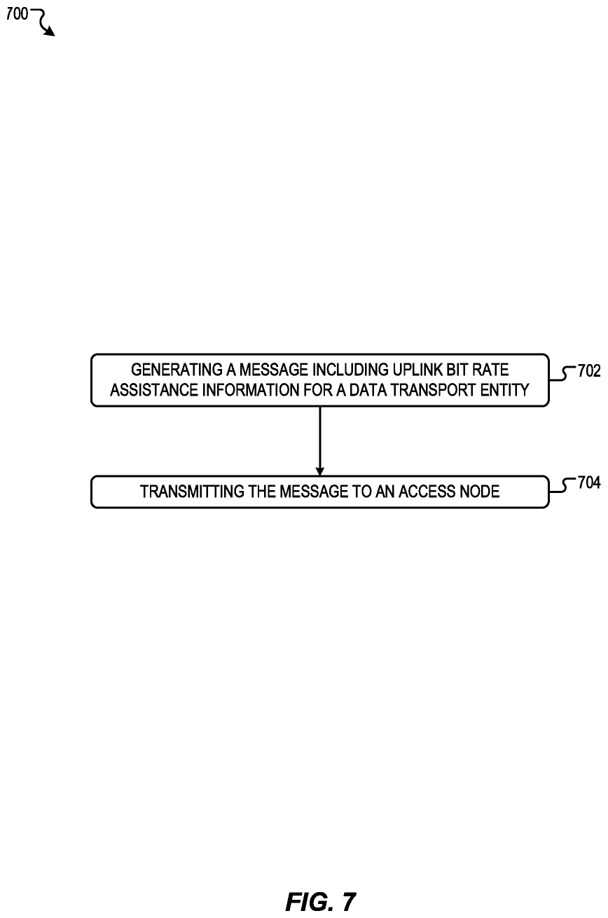

FIG. 7 illustrates a flowchart of an example method 700, according to some implementations. For clarity of presentation, the method 700 is described in the context of the preceding figures. For example, the method 700 can be performed by the UE 102 of FIG. 1, or any suitable system, environment, software, hardware, or combination thereof. In some implementations, operations of the method 700 can be run in parallel, in combination, in loops, or in any order. The example method 700 shown in FIG. 7 can be modified or reconfigured to include additional, fewer, or different steps (not shown in FIG. 7), which can be performed in the order shown or in a different order.

At 702, the method 700 includes generating a message including uplink bit rate assistance information for a data transport entity.

At 704, the method 700 includes transmitting the message to an access node.

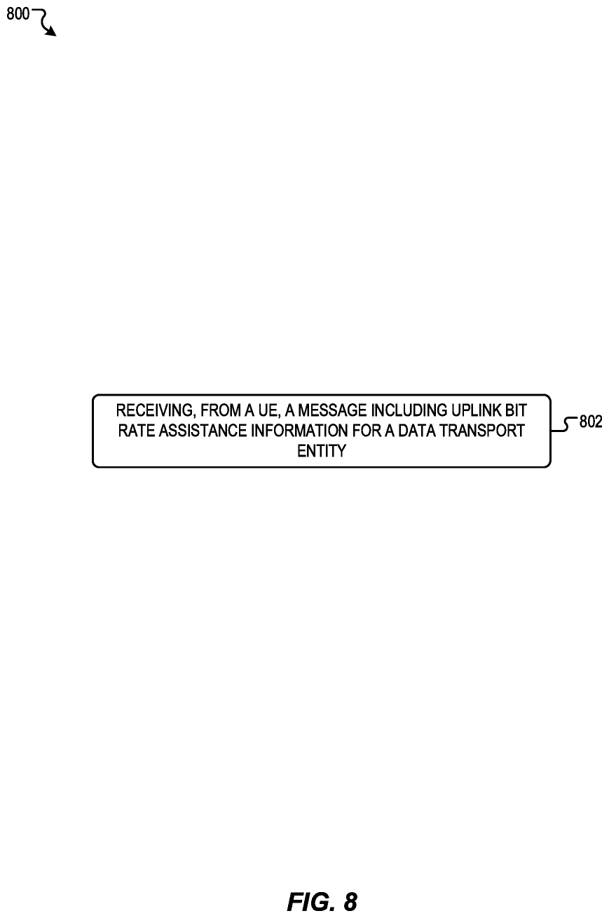

FIG. 8 illustrates a flowchart of an example method 800, according to some implementations. For clarity of presentation, the method 800 is described in the context of the preceding figures. For example, the method 800 can be performed by the UE 102 of FIG. 1, or any suitable system, environment, software, hardware, or combination thereof. In some implementations, operations of the method 800 can be run in parallel, in combination, in loops, or in any order. The example method 800 shown in FIG. 8 can be modified or reconfigured to include additional, fewer, or different steps (not shown in FIG. 8), which can be performed in the order shown or in a different order.

At 802, the method 800 includes receiving, from a UE, a message including uplink bit rate assistance information for a data transport entity.

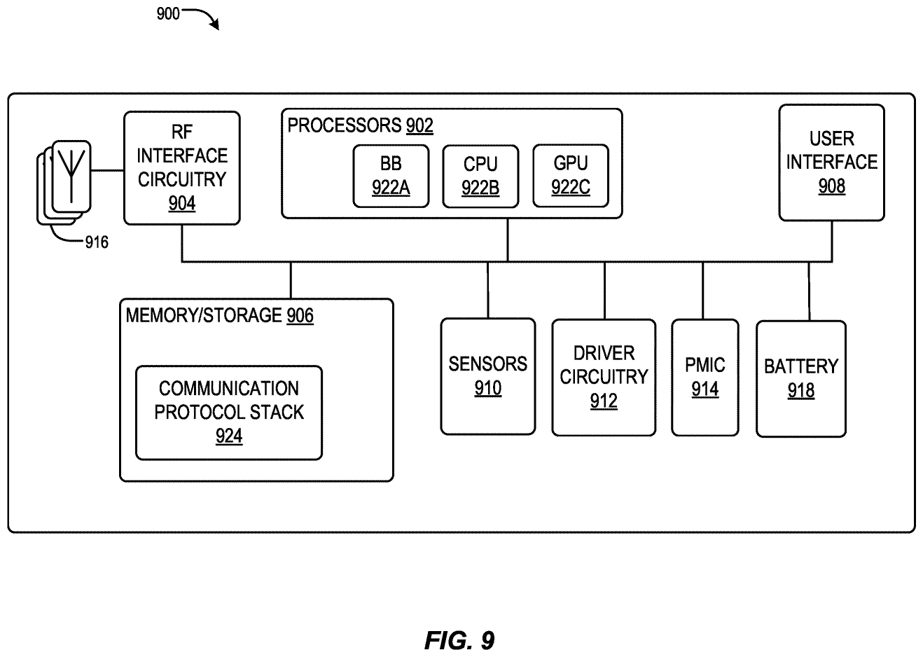

FIG. 9 illustrates an example UE 900. The UE 900 may be similar to and substantially interchangeable with UE 102 of FIG. 1.

The UE 900 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 900 may include any/all of processor 902, RF interface circuitry 904, memory/storage 906, user interface 908, sensors 910, driver circuitry 912, power management integrated circuit (PMIC) 914, one or more antenna(s) 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and a different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc., that allows various circuit components (on common or different chips or chipsets) to interact with one another.

The processor 902 may include one or more processors. For example, the processor 902 may include processor circuitry such as, for example, baseband processor circuitry (BB) 922A, central processor unit circuitry (CPU) 922B, and graphics processor unit circuitry (GPU) 922C. The processor 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by the processor 902 to cause the UE 900 to perform various operations described herein. The memory/storage 906 include any type of volatile or non-volatile memory that may be distributed throughout the UE 900. In some implementations, some of the memory/storage 906 may be located on the processor 902 itself (for example, L1 and L2 cache), while other memory/storage 906 is external to the processor 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 916 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 916. In various implementations, the RF interface circuitry 904 may be configured to transmit/receive signals in a manner compatible with NR access technologies.

The antenna(s) 916 may include one or more antenna elements to convert electrical signals into radio waves to travel through the air and to convert received radio waves over the air into electrical signals. In some implementations, the antenna elements may be arranged into one or more antenna panels. The antenna(s) 916 may have antenna panels that are omnidirectional, directional, or a combination thereof, to enable beamforming and multiple input, multiple output communications. The antenna(s) 916 may include any/all of microstrip antennas, printed antennas fabricated on the surface of one or more printed circuit boards, patch antennas, phased array antennas, etc. The antenna(s) 916 may have one or more panels designed for one or more specific frequency bands, such as bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processor 902, the PMIC 914 may control power-source selection, voltage scaling, battery charging, or DC-to-DC conversion.

In some implementations, the PMIC 914 may control, or otherwise be part of, various power saving mechanisms of the UE 900. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

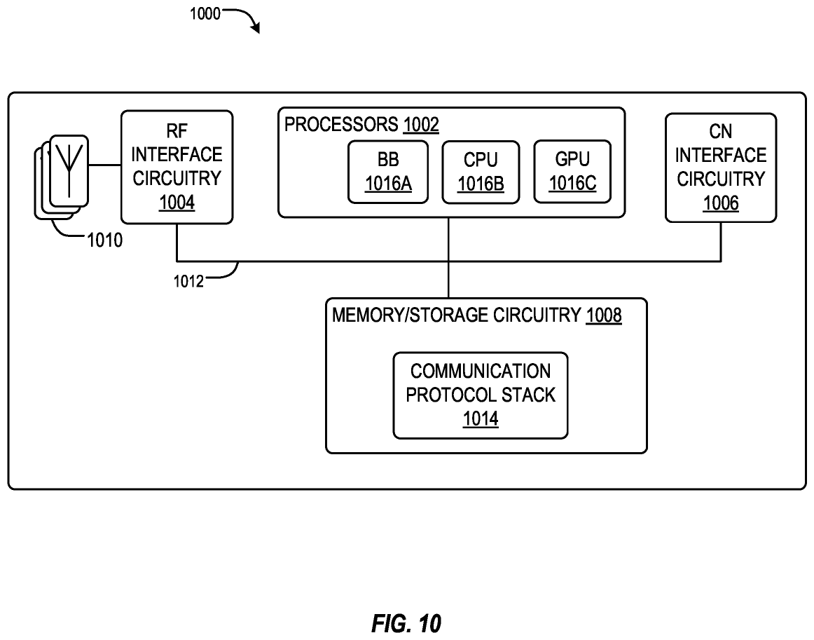

FIG. 10 illustrates an example access node 1000 (e.g., a base station or gNB), according to some implementations. The access node 1000 may be similar to and substantially interchangeable with base station 104. The access node 1000 may include one or more of processor 1002, RF interface circuitry 1004, core network (CN) interface circuitry 1006, memory/storage circuitry 1008, and one or more antenna(s) 1010. The processor 1002 may include any type of circuitry or processor circuitry that executes or otherwise operates computer-executable instructions, such as program code, software modules, or functional processes from memory/storage circuitry 1008 to cause the access node 1000 to perform operations as described herein.

The components of the access node 1000 may be coupled with various other components over one or more interconnects 1012. The processor 1002, RF interface circuitry 1004, memory/storage circuitry 1008 (including communication protocol stack 1014), antenna(s) 1010, and interconnects 1012 may be similar to like-named elements shown and described with respect to FIG. 9. For example, the processor 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In V2X scenarios, the access node 1000 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below.

Example 1 is a method including: generating a message including uplink bit rate assistance information for a data transport entity; and transmitting the message to an access node.

Example 2 includes the method of example 1, where the message is a first message, and further including: receiving a second message inquiring a bit rate of a UE.

Example 2 includes the method of example 1, where the uplink bit rate assistance information includes at least one of a target bit rate for the data transport entity, a minimum bit rate for the data transport entity, an offset between the target bit rate and the minimum bit rate for the data transport entity, or a list of supported bit rates for the data transport entity.

Example 4 includes the method of any of examples 1 to 3, where the data transport entity includes at least one of a QoS flow, an LCH, or a DRB.

Example 5 includes the method of any of examples 1 to 4, where transmitting the message includes transmitting a UAI message indicating the uplink bit rate assistance information for the data transport entity.

Example 6 includes the method of example 5, where an uplink traffic IE of the UAI message indicates the uplink bit rate assistance information for the data transport entity.

Example 7 includes the method of any of examples 1 to 6, where the message further indicates a desired latency budget for the data transport entity.

Example 8 includes the method of any of examples 1 to 7, where transmitting the message includes transmitting a MAC-CE indicating the uplink bit rate assistance information for the data transport entity.

Example 9 includes the method of any of examples 1 to 8, where transmitting the message includes transmitting a recommended bit rate query message indicating the uplink bit rate assistance information for the data transport entity.

Example 10 includes the method of example 9, where the recommended bit rate query message indicates the data transport entity to which the uplink bit rate assistance information is applicable.

Example 11 includes the method of any of examples 9 to 10, where the recommended bit rate query message includes an identifier or a bitmap for identification of the data transport entity.

Example 12 includes the method of any of examples 9 to 11, where the recommended bit rate query message indicates one or more desired bit rates for the data transport entity using a dynamic bit rate multiplier value.

Example 13 includes the method of example 12, further including receiving control signaling that configures a set of possible bit rate multiplier values for the data transport entity, where the dynamic bit rate multiplier value is selected from the set of possible bit rate multiplier values.

Example 14 includes the method of example 13, further including: receiving a semi-static control message indicating one or more bit rate parameters associated with the data transport entity; and generating the set of possible bit rate multiplier values based on the one or more bit rate parameters indicated by the semi-static control message.

Example 15 includes the method of example 14, where the one or more bit rate parameters include at least one of a maximum bit rate multiplier value, a minimum bit rate multiplier value, or a step size to use for generating the set of possible bit rate multiplier values.

Example 16 includes the method of any of examples 12 to 15, where the dynamic bit rate multiplier value is applicable to all logical data transport entities identified by the message.

Example 17 includes the method of any of examples 9 to 16, where a respective dynamic bit rate multiplier value is configured for each data transport entity identified by the message.

Example 18 includes the method of any of examples 9 to 17, where different subsets of possible bit rate multiplier values are configured for different logical data transport entities.

Example 19 includes the method of any of examples 9 to 18, where the recommended bit rate query message further indicates a bit rate table from which to identify a bit rate value.

Example 20 includes the method of example 19, further including: receiving a semi-static control message indicating one or more bit rate parameters associated with the data transport entity; and generating the bit rate table based on the one or more bit rate parameters indicated by the semi-static control message.

Example 21 includes the method of example 20, where the one or more bit rate parameters include at least one of a maximum bit rate value, a minimum bit rate value, or a step size to use for generating the bit rate table.

Example 22 includes the method of any of examples 19 to 21, where different bit rate parameters are configured for GBR logical data transport entities and non-GBR logical data transport entities.

Example 23 includes the method of any of examples 19 to 22, where different bit rate tables are configured for different logical data transport entities identified by the message.

Example 24 includes the method of any of examples 19 to 23, where the bit rate table is applicable to all logical data transport entities identified by the message.

Example 25 includes the method of any of examples 1 to 24, where the message is a first message, and further including: receiving a second message indicating a recommended uplink bit rate to use for the data transport entity, where the recommended uplink bit rate is based on the uplink bit rate assistance information; and transmitting uplink data associated with the data transport entity based on the recommended uplink bit rate indicated by the second message.

Example 26 includes the method of example 25, where receiving the second message includes receiving a MAC-CE indicating the recommended uplink bit rate for the data transport entity.

Example 27 includes the method of any of examples 25 to 26, where receiving the second message includes receiving a bit rate recommendation message indicating the recommended uplink bit rate for the data transport entity.

Example 28 includes the method of example 27, further including determining the recommended uplink bit rate for the data transport entity based on a dynamic bit rate multiplier value indicated by the bit rate recommendation message.

Example 29 includes the method of any of examples 1 to 28, further including: starting a prohibit timer in response to transmitting the message including the uplink bit rate assistance information for the data transport entity; and refraining from transmitting additional uplink bit rate assistance information for the data transport entity until the prohibit timer has expired.

Example 30 includes the method of example 29, where different prohibit timer values are configured for different logical data transport entities.

Example 31 includes the method of any of examples 29 to 30, where a common prohibit timer value is configured for all logical data transport entities.

Example 32 includes the method of any of examples 29 to 31, further including: stopping the prohibit timer for the data transport entity prior to expiration of the prohibit timer; and transmitting a second message including additional uplink bit rate assistance information for a set of logical data transport entities including the data transport entity.

Example 33 includes the method of example 32, further including restarting the prohibit timer for the data transport entity in response to transmitting the second message.

Example 34 includes the method of any of examples 32 to 33, where stopping the prohibit timer for the data transport entity includes stopping the prohibit timer in response to detecting a change in a buffer associated with the data transport entity, where detecting the change includes determining that a high-priority packet is present in the buffer associated with the data transport entity.

Example 35 is an apparatus including: one or more processors; and memory storing instructions that, when executed, cause the one or more processors to perform the method of any of examples 1-34.

Example 36 is a UE including at least one processor configured to perform the method of any of examples 1-34.

Example 37 is a baseband processor configured to perform the method of any of examples 1-34.

Example 38 is a method including: receiving, from a UE, a message including uplink bit rate assistance information for a data transport entity.

Example 39 includes the method of example 38, where the message is a first message, and further including: transmitting a second message inquiring a bit rate of a UE.

Example 40 includes the method of any of examples 38 to 39, where the message is a first message, and further including: transmitting a second message indicating a recommended uplink bit rate to use for the data transport entity, where the recommended uplink bit rate is based on the uplink bit rate assistance information; and receiving uplink data associated with the data transport entity based on the recommended uplink bit rate indicated by the second message.

Example 41 includes the method of any of examples 38 to 40, where the uplink bit rate assistance information includes at least one of a target bit rate for the data transport entity, a minimum bit rate for the data transport entity, an offset between the target bit rate and the minimum bit rate for the data transport entity, or a list of supported bit rates for the data transport entity.

Example 42 includes the method of any of examples 38 to 41, where the data transport entity includes at least one of a QoS flow, an LCH, or a DRB.

Example 43 includes the method of any of examples 38 to 42, where receiving the message includes receiving a UAI message indicating the uplink bit rate assistance information for the data transport entity.

Example 44 includes the method of any of examples 38 to 43, where receiving the message includes receiving a recommended bit rate query message indicating the uplink bit rate assistance information for the data transport entity.

Example 45 includes the method of example 44, where the recommended bit rate query message indicates one or more desired bit rates for the data transport entity using a dynamic bit rate multiplier value.

Example 46 is an apparatus including: one or more processors; and memory storing instructions that, when executed, cause the one or more processors to perform the method of any of examples 38-45.

Example 47 is a base station including at least one processor configured to perform the method of any of examples 38-45.

Example 48 is a baseband processor configured to perform the method of any of examples 38-45.

Any of the foregoing examples can be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For example, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For example, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

1-26. (canceled)

27. A method comprising:
generating a message comprising uplink bit rate assistance information for a data transport entity;
transmitting the message to an access node; and
starting a bit rate query prohibit timer based at least in part on transmitting the message comprising the uplink bit rate assistance information for the data transport entity.

28. The method of claim 27, wherein the message is a first message, and further comprising:
receiving a second message inquiring a bit rate of a user equipment (UE).

29. The method of claim 27, wherein the uplink bit rate assistance information comprises at least one of a target bit rate for the data transport entity, a minimum bit rate for the data transport entity, an offset between the target bit rate and the minimum bit rate for the data transport entity, or a list of supported bit rates for the data transport entity.

30. The method of claim 27, wherein the data transport entity comprises at least one of a quality of service (QOS) flow, a logical channel (LCH), or a data radio bearer (DRB).

31. The method of claim 27, wherein transmitting the message comprises transmitting at least one of a user equipment (UE) assistance information (UAI) message, a medium access control (MAC) control element (MAC-CE), or a recommended bit rate query message indicating the uplink bit rate assistance information for the data transport entity.

32. The method of claim 31, wherein the recommended bit rate query message indicates one or more desired bit rates for the data transport entity using a dynamic bit rate multiplier value.

33. The method of claim 32, further comprising receiving control signaling that configures a plurality of possible bit rate multiplier values for the data transport entity, wherein the dynamic bit rate multiplier value is selected from the plurality of possible bit rate multiplier values.

34. The method of claim 33, further comprising:
receiving a semi-static control message indicating one or more bit rate parameters associated with the data transport entity; and
generating the plurality of possible bit rate multiplier values based at least in part on the one or more bit rate parameters indicated by the semi-static control message.

35. The method of claim 34, wherein the one or more bit rate parameters comprise at least one of a maximum bit rate multiplier value, a minimum bit rate multiplier value, or a step size to use for generating the plurality of possible bit rate multiplier values.

36. The method of claim 31, wherein the recommended bit rate query message further indicates a bit rate table from which to identify a bit rate value.

37. The method of claim 36, further comprising:
receiving a semi-static control message indicating one or more bit rate parameters associated with the data transport entity; and
generating the bit rate table based at least in part on the one or more bit rate parameters indicated by the semi-static control message.

38. The method of claim 27, wherein the message is a first message, and further comprising:
receiving a second message indicating a recommended uplink bit rate to use for the data transport entity, wherein the recommended uplink bit rate is based at least in part on the uplink bit rate assistance information; and
transmitting uplink data associated with the data transport entity based at least in part on the recommended uplink bit rate indicated by the second message.

39. The method of claim 38, wherein receiving the second message comprises receiving a medium access control (MAC) control element (CE) or a bit rate recommendation message indicating the recommended uplink bit rate for the data transport entity.

40. The method of claim 27, further comprising:
refraining from transmitting additional uplink bit rate assistance information for the data transport entity until the bit rate query prohibit timer has expired.

41. The method of claim 40, further comprising:
stopping the bit rate query prohibit timer for the data transport entity prior to expiration of the bit rate query prohibit timer; and
transmitting a second message comprising additional uplink bit rate assistance information for a plurality of logical data transport entities including the data transport entity.

42. The method of claim 41, wherein stopping the bit rate query prohibit timer for the data transport entity comprises stopping the bit rate query prohibit timer in response to detecting a change in a buffer associated with the data transport entity,
wherein detecting the change comprises determining that a high-priority packet is present in the buffer associated with the data transport entity.

43. A method comprising:
transmitting control signaling that configures a UE to start a bit rate query prohibit timer in association with transmitting uplink bit rate assistance information for a data transport entity; and
receiving, from the UE, a message comprising the uplink bit rate assistance information for the data transport entity.

44. The method of claim 43, wherein the uplink bit rate assistance information comprises at least one of a target bit rate for the data transport entity, a minimum bit rate for the data transport entity, an offset between the target bit rate and the minimum bit rate for the data transport entity, or a list of supported bit rates for the data transport entity.

45. The method of claim 43, wherein the data transport entity comprises at least one of a QoS flow, an LCH, or a DRB.

46. An apparatus comprising:
one or more processors; and
memory storing instructions that, when executed by the one or more processors, cause the apparatus to perform operations comprising:
generating a message comprising uplink bit rate assistance information for a data transport entity;
transmitting the message to an access node; and
starting a bit rate query prohibit timer based at least in part on transmitting the message comprising the uplink bit rate assistance information for the data transport entity.
